(19) United States
(12) Patent Application Publication
(10) Pub. No.: US 2025/0329136 A1
(43) Pub. Date: Oct. 23, 2025

(54) METHOD, SYSTEM, AND COMPUTING-READABLE RECORDING MEDIUM FOR CLASSIFYING EACH PARCEL IN AERIAL IMAGE

(71) Applicant: SI Analytics Co., Ltd., Daejeon (KR)

(72) Inventor: Do Young JEONG, Daejeon (KR)

(21) Appl. No.: 18/747,109

(22) Filed: Jun. 18, 2024

(30) Foreign Application Priority Data
Apr. 18, 2024 (KR) 10-2024-0051969

(51) Int. Cl. G06V 10/764; G06T 3/40; G06T 7/12; G06V 20/17

(52) U.S. Cl. CPC G06V 10/764; G06T 3/40; G06T 7/12; G06V 20/17; G06V 2201/07

(57) ABSTRACT

The present invention relates to a method, a system, and a computing-readable recording medium for classifying each parcel in an aerial image, in which the method includes: inputting the aerial image to an instance segmentation model to generate instance segmentation information for a parcel, and comparing digitized parcel data in a region included in the aerial image with the instance segmentation information to determine parcel object information in the aerial image; and inputting, based on the parcel object information of the aerial image, image information of each of a plurality of parcels extracted from the aerial image or image characteristic data including data derived from the image information to a classification model to assign a class to each of the parcels.

### BACKGROUND OF THE INVENTION

### 1. Field of the Invention

The present invention relates to a method, a system, and a computing-readable recording medium for classifying each parcel in an aerial image, and more particularly, to a method, a system, and a computing-readable recording medium for classifying each parcel in an aerial image, in which the method includes: inputting the aerial image to an instance segmentation model to generate instance segmentation information for a parcel, and comparing digitized parcel data in a region included in the aerial image with the instance segmentation information to determine parcel object information in the aerial image; and inputting, by reflecting the parcel object information of the aerial image, image information of each of a plurality of parcels extracted from the aerial image or image characteristic data including data derived from the image information to a classification model to assign a class to each of the parcels.

### 2. Description of the Related Art

The domestic agricultural product market has been losing stability in recent years due to imbalance in supply and demand of agricultural products and an insufficient distribution structure. Such a problem is emerging as a serious problem causing price fluctuations in the agricultural product market due to discordance between supply and demand, so that farmers and consumers are experiencing difficulties. In particular, production of agricultural products has become unstable due to recent climate changes and natural disasters, making the problem even worse.

Recognition of an exact current state of agricultural product cultivation is very important to maintain stability of the market and guarantee income of farmers. However, recognition of the exact current state through complete enumeration is a time-consuming and expensive task, which has to be performed over a wide area, so that this is a difficult object to be achieved in reality. Accordingly, difficulties are arising in predicting prices and ensuring stability in the agricultural product market. Therefore, it is necessary to find a more efficient scheme for recognizing a current state of agricultural product cultivation.

Meanwhile, Korean Patent Registration No. 10-2245337 relates to a crop classification method employing a weight based on an error matrix, and discloses a configuration for classifying a crop based on colors of the crop at various positions through multiple image recognition by using a crop classification learning scheme employing a weight based on an error matrix.

However, the patent does not disclose a configuration for inputting an aerial image to an instance segmentation model to generate instance segmentation information, and comparing digitized parcel data with the instance segmentation information to determine parcel object information, and a configuration for inputting image information of each of a plurality of parcels extracted from the aerial image or image characteristic data including data derived from the image information to a classification model to assign a class to each of the parcels.

### SUMMARY OF THE INVENTION

The present invention relates to a method, a system, and a computing-readable recording medium for classifying each parcel in an aerial image, and more particularly, an object of the present invention is to provide a method, a system, and a computing-readable recording medium for classifying each parcel in an aerial image, in which the method includes: inputting the aerial image to an instance segmentation model to generate instance segmentation information for a parcel, and comparing digitized parcel data in a region included in the aerial image with the instance segmentation information to determine parcel object information in the aerial image; and inputting, based on the parcel object information of the aerial image, image information of each of a plurality of parcels extracted from the aerial image or image characteristic data including data derived from the image information to a classification model to assign a class to each of the parcels.

To achieve the objects described above, according to one embodiment of the present invention, there is provided a method for classifying each parcel in an aerial image, which is performed by a computing device including at least one processor and at least one memory, the method including: a parcel instance segmentation step of inputting the aerial image to an instance segmentation model to generate instance segmentation information for an object identified in the aerial image, and comparing digitized parcel data in a region included in the aerial image with the instance segmentation information to determine parcel object information including information on a boundary of a parcel identified in the aerial image; and a classification step of inputting, based on the parcel object information of the aerial image, image information of each of a plurality of parcels extracted from the aerial image or image characteristic data including data derived from the image information to a classification model trained with deep learning to assign a class to each of the parcels.

According to one embodiment of the present invention, the instance segmentation model may include a segment anything model (SAM) model trained with deep learning and configured to identify the parcel in the aerial image that has been received to generate the instance segmentation information.

According to one embodiment of the present invention, the class may include information on a crop being cultivated on the parcel, the crop including at least one of the following: cabbage, radish, rice, corn, beans, and chili pepper.

According to one embodiment of the present invention, the parcel instance segmentation step may include downsampling the aerial image to increase recognizability of a segmentation target object in the aerial image.

According to one embodiment of the present invention, the parcel instance segmentation step may include generating instance segmentation information from each of a plurality of aerial images, which are obtained by capturing regions including a same target region, and comparing each of a plurality of pieces of instance segmentation information with the digitized parcel data to determine a plurality of pieces of parcel object information for the aerial images, respectively.

According to one embodiment of the present invention, each of the aerial images may include sequential image data corresponding to images extracted from aerial image data, which are obtained by capturing the regions including the target region at different time points.

According to one embodiment of the present invention, the classification step may include assigning a class to each of a plurality of parcels that are commonly identified in a plurality of aerial images based on image information of each of the parcels or image characteristic data including data derived from the image information, which is extracted from each of the aerial images obtained by capturing regions including a same target region.

According to one embodiment of the present invention, the information or data that is input to the classification model may include: image information on an unprocessed original image of a parcel identified in one of the aerial images; and image characteristic data extracted from an image of a parcel identified in another one of the aerial images.

According to one embodiment of the present invention, the information or data that is input to the classification model may include at least one of temporal information on a time point including at least one of a date, a time, and a season at which the aerial image has been captured, and spatial information on a space including at least one of a region code, a latitude, and a longitude in which the aerial image has been captured.

To achieve the objects described above, according to one embodiment of the present invention, there is provided a system for classifying each parcel in an aerial image, wherein the system is configured to perform: a parcel instance segmentation step of inputting the aerial image to an instance segmentation model to generate instance segmentation information for an object identified in the aerial image, and comparing digitized parcel data in a region included in the aerial image with the instance segmentation information to determine parcel object information including information on a boundary of a parcel identified in the aerial image; and a classification step of inputting, based on the parcel object information of the aerial image, image information of each of a plurality of parcels extracted from the aerial image or image characteristic data including data derived from the image information to a classification model trained with deep learning to assign a class to each of the parcels.

According to one embodiment of the present invention, the classification step may include assigning a class to each of a plurality of parcels that are commonly identified in a plurality of aerial images based on the image information of each of the parcels or the image characteristic data including the data derived from the image information, which is extracted from each of the aerial images obtained by capturing regions including a same target region.

To achieve the objects described above, according to one embodiment of the present invention, there is provided a computing-readable recording medium for implementing a method for classifying each parcel in an aerial image, which is performed by a computing device including at least one processor and at least one memory, wherein the computing-readable recording medium stores instructions that allow the computing device to perform: a parcel instance segmentation step of inputting the aerial image to an instance segmentation model to generate instance segmentation information for an object identified in the aerial image, and comparing digitized parcel data in a region included in the aerial image with the instance segmentation information to determine parcel object information including information on a boundary of a parcel identified in the aerial image; and a classification step of inputting, for each of a plurality of parcels extracted from the aerial image by reflecting the parcel object information of the aerial image, image information of the parcel or image characteristic data including data derived from the image information to a classification model trained with deep learning to assign a class to each of the parcels.

According to one embodiment of the present invention, the classification step includes assigning a class to each of a plurality of parcels that are commonly identified in a plurality of aerial images based on image information of each of the parcels or image characteristic data including data derived from the image information, which is extracted from each of the aerial images obtained by capturing regions including a same target region.

According to one embodiment of the present invention, coordinate information of instance segmentation information and digitized parcel data may be adjusted to allow the coordinate information of the digitized parcel data and the instance segmentation information to match each other, so that an error caused by a difference in position can be reduced when the digitized parcel data and the instance segmentation information are compared with each other.

According to one embodiment of the present invention, instance segmentation information generated by inputting an aerial image to an instance segmentation model and digitized parcel data may be compared with each other to derive parcel object information, so that the need for precise matching can be bypassed, and a plurality of time-series aerial images extracted at different time points can be utilized more effectively.

According to one embodiment of the present invention, a remaining region that has not been determined as parcel object information in an aerial image may be masked and input to a classification model, so that a computational load on a computing resource can be reduced.

According to one embodiment of the present invention, a parcel instance segmentation step may include masking and inputting a remaining region that has not been determined as parcel object information in an aerial image to a classification model, so that information that does not correspond to the parcel object information can be prevented from affecting a process of assigning a class, and thus performance of the classification model can be improved.

According to one embodiment of the present invention, a class may be assigned to each of a plurality of parcels by using image characteristic data including data derived from image information for each of a plurality of parcels, so that a computational load on a computing resource can be reduced.

According to one embodiment of the present invention, a class may be assigned to each of the plurality of parcels by identifying each of the parcels as an object in an aerial image and inputting information extracted from each of the identified parcels to a classification model, so that the class can be assigned more rapidly to each of the parcels as compared with a process of assigning a class to each of a plurality of parcels by inputting image information on an original aerial image, and accuracy of the classification model can be improved.

According to one embodiment of the present invention, a class may be assigned to a parcel in consideration of image information of the parcel extracted from a reference time point image at a specific time point as well as image characteristic data reflecting data on a time-series change extracted from each of a plurality of aerial images except for the reference time point image, so that performance of a classification model can be improved.

### BRIEF DESCRIPTION OF THE DRAWINGS

FIGS. 1A and 1B schematically show a process and a result of a system and a method for classifying each parcel in an aerial image according to one embodiment of the present invention.

FIG. 2 schematically shows components for implementing the system and the method for classifying each parcel in the aerial image according to one embodiment of the present invention.

FIG. 3 schematically shows steps in the system and the method for classifying each parcel in the aerial image according to one embodiment of the present invention.

FIGS. 4A and 4B schematically show a downsampling step according to one embodiment of the present invention.

FIG. 5 schematically shows a candidate parcel object generation step according to one embodiment of the present invention.

FIG. 6 schematically shows a coordinate transformation step according to one embodiment of the present invention.

FIG. 7 schematically shows a parcel object information determination step according to one embodiment of the present invention.

FIGS. 8A and 8B schematically show a classification step according to one embodiment of the present invention.

FIG. 9 schematically shows a reference time point image selection step and an image characteristic data extraction step according to one embodiment of the present invention.

FIG. 10 schematically shows a crop class assignment step according to one embodiment of the present invention.

FIG. 11 schematically shows internal components of the computing device according to one embodiment of the present invention.

### DETAILED DESCRIPTION OF THE INVENTION

The “user terminal” mentioned below may be implemented as a computer or a portable terminal that may access a server or another terminal through a network. The computer described herein may include, for example, a notebook computer, a desktop computer, a laptop computer, and the like in which a web browser is mounted, and the portable terminal is, for example, a wireless communication device in which portability and mobility are guaranteed, and may include all kinds of handheld-based wireless communication devices such as a smartphone, a personal communication System (PCS), a global system for mobile communications (GSM), a personal digital cellular (PDC), a personal handyphone system (PHS), a personal digital assistant (PDA), an international mobile telecommunication (IMT)-2000, a code division multiple access (CDMA)-2000, a W-code division multiple access (W-CDMA), a wireless broadband Internet (Wibro) terminal, and the like. In addition, the “network” may be implemented as a wired network such as a local area network (LAN), a wide area network (WAN), or a value added network (VAN), or all types of wireless networks such as a mobile radio communication network or a satellite communication network.

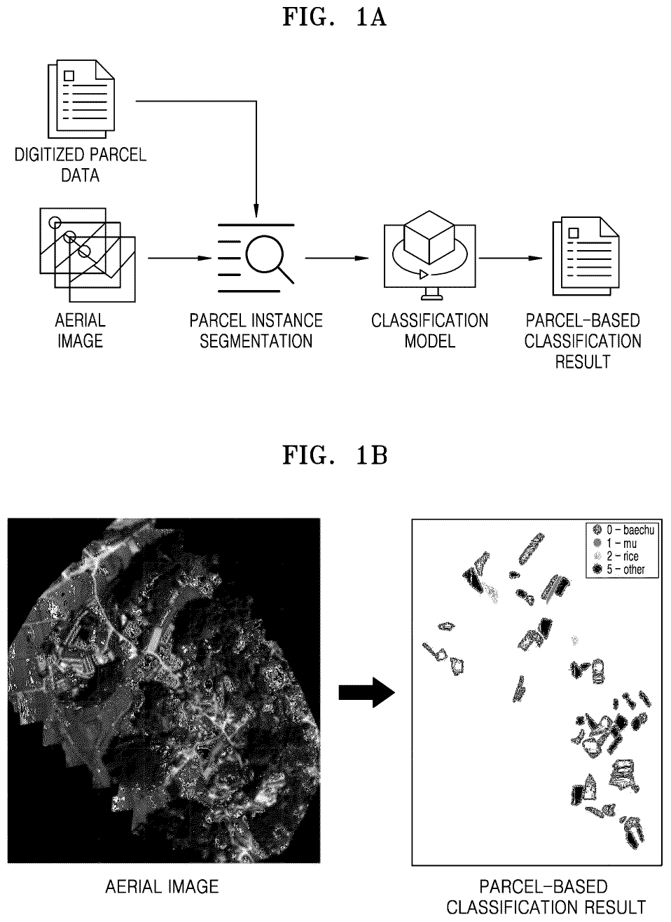

FIG. 1 schematically shows a process and a result of a system and a method for classifying each parcel in an aerial image according to one embodiment of the present invention.

As shown in FIG. 1A, a classification system 1 according to the present invention may assign a class to each of a plurality of parcels of an aerial image that has been received.

In detail, the aerial image may be an image obtained by aerially capturing an agricultural land in order to identify and classify a type of a crop cultivated in each parcel of an extensive agricultural land.

Preferably, the aerial image may be an image including at least one of images captured from a drone, a satellite, or an airplane.

According to one embodiment of the present invention, when the aerial image is received, the classification system 1 may identify and extract each of a plurality of parcels in the aerial image as an object, and assign a class to each of the parcels extracted as the object.

Alternatively, as shown in FIG. 1A, the classification system 1 may identify and extract each of a plurality of parcels in the aerial image that has been received as an object and compare the parcels with digitized parcel data to perform parcel instance segmentation, and may input information on segmented parcel objects to a classification model to assign a class to each parcel.

In one embodiment of the present invention, the digitized parcel data may include a smart farm map, and the smart farm map may be a map in which a land that is being actually cultivated is partitioned by an area, a property (rice field, farming field, facility, fruit tree), and the like by utilizing an aerial image and the like.

For example, as shown in FIG. 1B, the aerial image may include an image of an extensive agricultural land, which is aerially captured, and the classification system 1 may assign a class to each of a plurality of parcels identified in the aerial image.

As a result, as shown on a left side of FIG. 1B, the aerial image may correspond to data that is input to the classification system 1 according to the present invention, and the classification system 1 may assign a class to each of a plurality of parcels in the aerial image.

Meanwhile, according to one embodiment of the present invention, each of a plurality of aerial images may include sequential data corresponding to a plurality of images extracted from aerial image data, which are obtained by capturing regions including a target region at different time points, which will be described in detail below.

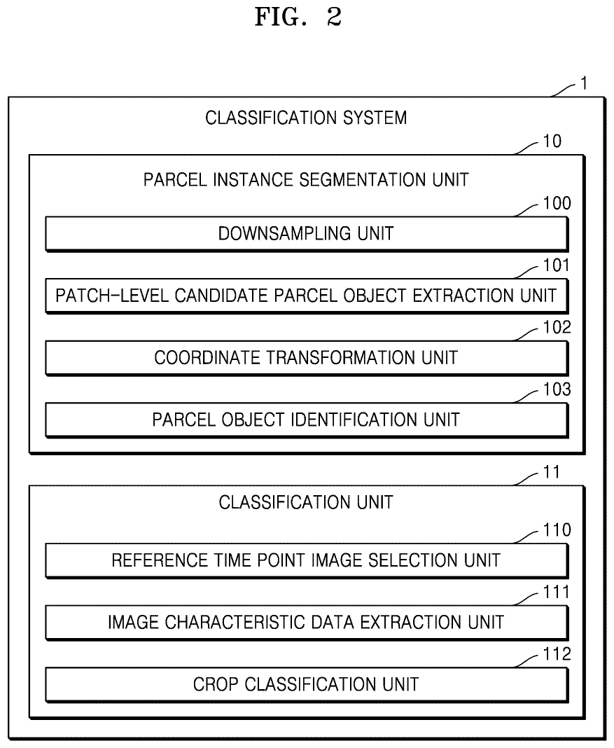

FIG. 2 schematically shows components for implementing the system and the method for classifying each parcel in the aerial image according to one embodiment of the present invention.

The classification system 1 may extract each of the parcels identified in the aerial image that has been received, and assign a class to each of the extracted parcels.

In detail, the classification system 1 may include: a parcel instance segmentation unit 10 configured to input an aerial image to an instance segmentation model to generate instance segmentation information, and compare the generated instance segmentation information with digitized parcel data to determine parcel object information including information on a boundary of a parcel in the aerial image; and a classification unit 11 configured to input image information for each of a plurality of parcels extracted from the aerial image or image characteristic data to a classification model to assign a class to each of the parcels.

The parcel instance segmentation unit 10 may include: a downsampling unit 100 configured to adjust a size of the aerial image to input the aerial image to the instance segmentation model; a Patch-level Candidate Parcel Object Extraction unit 101 configured to input each of a plurality of partial aerial images, which are generated by segmenting the aerial image that has been downsampled into a preset patch size, to the instance segmentation model to identify a candidate parcel object for each of the partial aerial images; a coordinate transformation unit 102 configured to merging a plurality of candidate parcel objects to generate the instance segmentation information, and adjust coordinate information of the instance segmentation information and the digitized parcel data to allow the coordinate information of the digitized parcel data and the instance segmentation information to match each other; and a parcel object identification unit 103 configured to compare each of the candidate parcel objects of the instance segmentation information with the digitized parcel data to determine, when a region that overlaps by a preset proportion or more exists, the region as the parcel object information.

The classification unit 11 may include: a reference time point image selection unit 110 configured to select one of the aerial images as a reference time point image; an image characteristic data extraction unit 111 configured to extract image information of each of the parcels from each of the aerial images, and additionally derive image characteristic data from the image information of each of the parcels extracted from each of the aerial images except for the reference time point image; and a crop classification unit 112 configured to input, for each of the parcels in the aerial image, sequential data in which image information of the reference time point image and image characteristic data of the aerial images except for the reference time point image are arranged in a time-series order to the classification model to assign the class to the parcel.

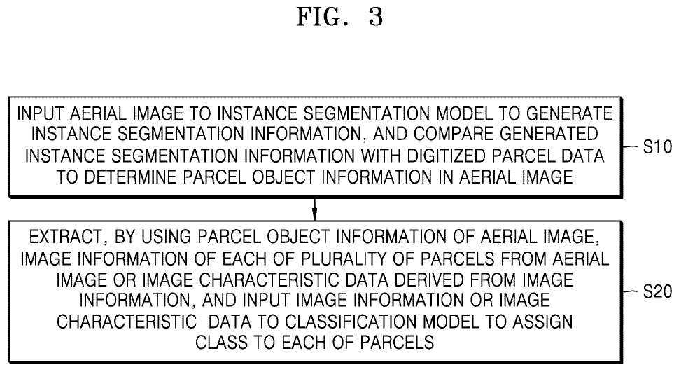

FIG. 3 schematically shows steps in the system and the method for classifying each parcel in the aerial image according to one embodiment of the present invention.

As shown in FIG. 3, a method for classifying each parcel in an aerial image may include: a parcel instance segmentation step of inputting the aerial image to an instance segmentation model to generate instance segmentation information for an object identified in the aerial image, and comparing digitized parcel data in a region included in the aerial image with the instance segmentation information to determine parcel object information including information on a boundary of a parcel identified in the aerial image; and a classification step of inputting, for each of a plurality of parcels extracted from the aerial image by reflecting the parcel object information of the aerial image, image information of the parcel or image characteristic data including data derived from the image information to a classification model trained with deep learning to assign a class to each of the parcels.

The step S10 may be a step of inputting an aerial image to an instance segmentation model to generate instance segmentation information for an object identified in the aerial images, and comparing the generated instance segmentation information with digitized parcel data to determine parcel object information within the aerial image.

The step S20 may be a step of inputting, based on the parcel object information of the aerial image, image information of each of a plurality of parcels extracted from the aerial image or image characteristic data including data derived from the image information to a classification model to assign a class to each of the parcels.

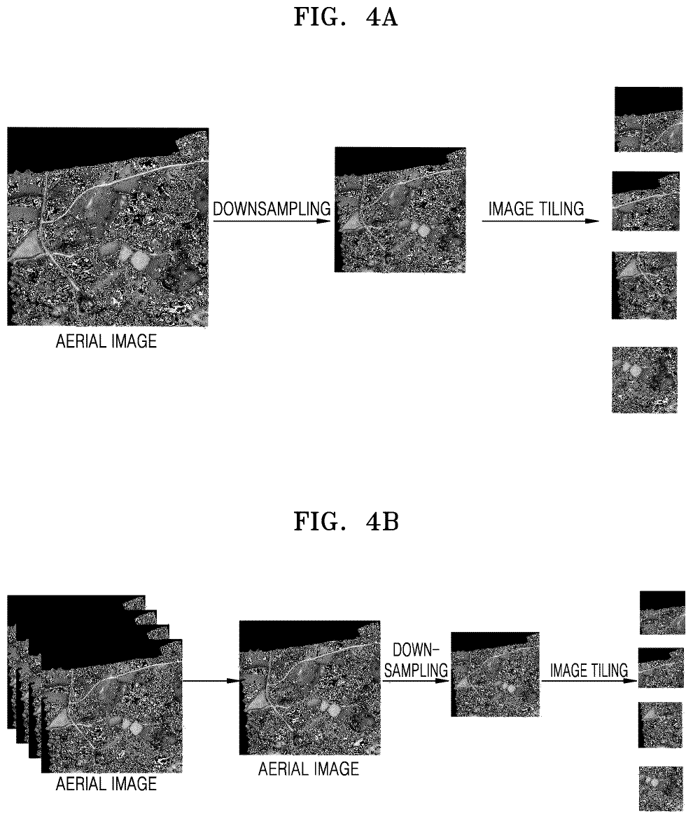

FIGS. 4A and 4B schematically show a downsampling step according to one embodiment of the present invention.

As shown in FIGS. 4A and 4B, the aerial image may be downsampled to increase recognizability of a segmentation target object in the aerial image

In detail, a size of the aerial image may be adjusted and downsampled to input the aerial image to the instance segmentation model, and the aerial image that has been downsampled may be segmented into a preset patch size to generate a plurality of partial aerial images.

Preferably, the downsampling may be a process of reducing a spatial resolution of the aerial image to input the aerial image to the instance segmentation model.

As shown in FIG. 4B, the size of the aerial image may be adjusted to input each of the aerial images to the instance segmentation model.

In detail, the size of each of the aerial images may be adjusted and downsampled to input each of the aerial images to the instance segmentation model, and each of the aerial images that have been downsampled may be segmented into a preset patch size to generate a plurality of partial aerial images.

Preferably, the size of the aerial image that allows the aerial image to be input to the instance segmentation model may be preset, and each of the aerial images may be adjusted to fit the preset size.

According to one embodiment of the present invention, each of the aerial images may include sequential image data corresponding to images extracted from aerial image data, which are obtained by capturing regions including the same target region at different time points.

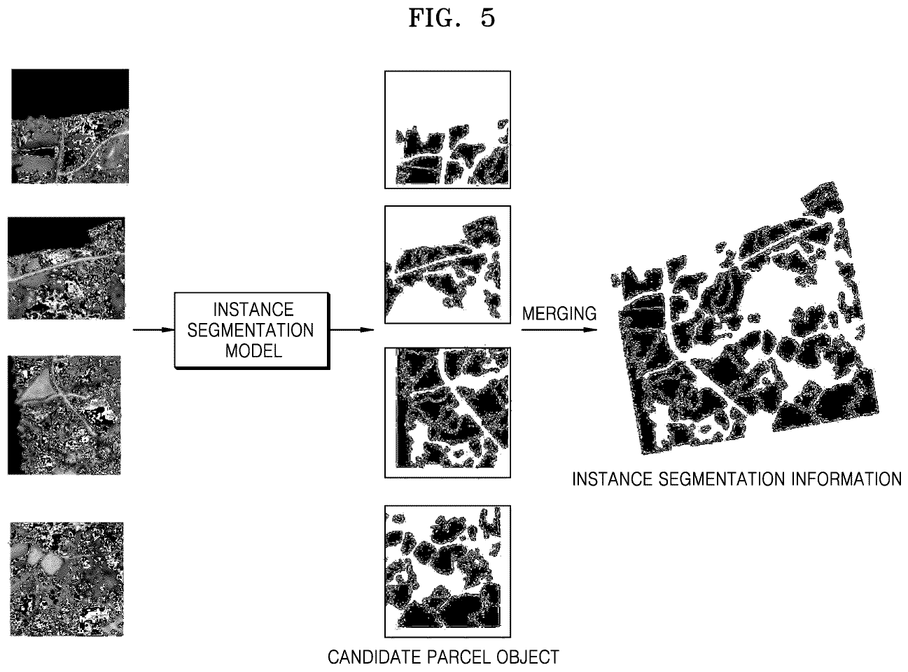

FIG. 5 schematically shows a candidate parcel object generation step according to one embodiment of the present invention.

As shown in FIG. 5, each of the partial aerial images may be input to the instance segmentation model to identify a plurality of candidate parcel objects in each of the partial aerial images, and the candidate parcel objects may be merged to generate instance segmentation information for the aerial image.

In detail, the instance segmentation model may identify information on a boundary of each of the parcels in the partial aerial image to extract each of the candidate parcel objects.

Preferably, each of the partial aerial images may be input to the instance segmentation model to identify the information on the boundary of each of the parcels in each of the partial aerial images so as to extract the candidate parcel object, and the candidate parcel objects may be merged to identify the information on the boundary of each of the parcels in the aerial image to determine the instance segmentation information.

According to one embodiment of the present invention, the candidate parcel object may be an image obtained by extracting each of the parcels identified in the partial aerial image.

In detail, the candidate parcel object may be an image obtained by inputting the partial aerial image to the instance segmentation model to extract each of the parcels identified in the partial aerial image.

According to one embodiment of the present invention, for each of the parcels identified in the aerial image, the instance segmentation information may be an image that displays only a region identified as a parcel except for a region that is not identified as a parcel in the aerial image.

According to one embodiment of the present invention, the instance segmentation model may include a segment anything model (SAM) model trained with deep learning and configured to identify the parcel in the aerial image that has been received to generate the instance segmentation information.

In detail, the SAM model may be an image segmentation model that may be trained with a wide range of large data sets and may perform various tasks in new data distributions through prompt engineering.

In detail, the SAM model may perform the prompt engineering for deriving a desired result for a specific task through a prompt, and an available prompt may include at least one of a point, box, and a text.

Preferably, the SAM model may more accurately segment a segmentation target object on an image by using a point, a box, a text, and the like, which are components of the prompt.

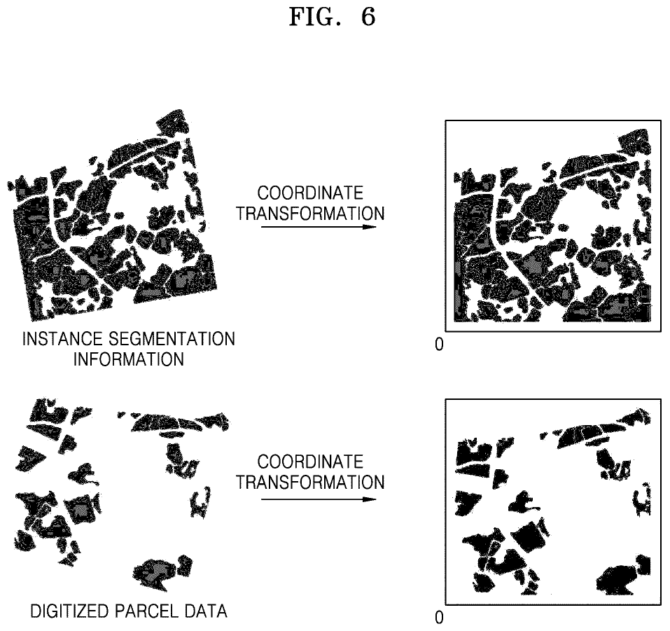

FIG. 6 schematically shows a coordinate transformation step according to one embodiment of the present invention.

As shown in FIG. 6, coordinate information of instance segmentation information and digitized parcel data may be adjusted to allow the coordinate information of the digitized parcel data and the instance segmentation information to match each other.

In detail, the instance segmentation information and the digitized parcel data may be converted into an image coordinate system, and the instance segmentation information and the digitized parcel data may be compared with each other under the image coordinate system.

As described above, coordinate information of instance segmentation information and digitized parcel data may be adjusted to allow the coordinate information of the digitized parcel data and the instance segmentation information to match each other, so that an error caused by a difference in position may be reduced when the digitized parcel data and the instance segmentation information are compared with each other.

According to one embodiment of the present invention, the digitized parcel data may have the same image size as the instance segmentation information.

According to one embodiment of the present invention, the image coordinate system may be a coordinate system used to handle an image, which may define a position in a unit of a pixel of the image.

In detail, each pixel of the image may represent a unique position within the image, and coordinates may be generally expressed by using a horizontal direction as an x-axis and a vertical direction as a y-axis.

Preferably, an upper left corner of the image may be set to have coordinates of (0, 0), the x-axis may be increased in a right direction, and the y-axis may be increased in a downward direction. When coordinates are defined in this way, each pixel may identify a unique position within the image.

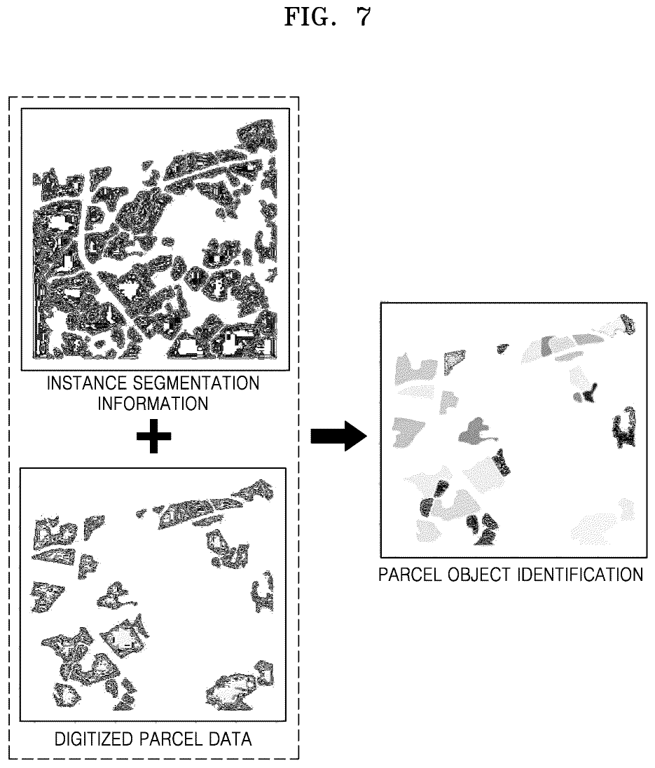

FIG. 7 schematically shows a parcel object information determination step according to one embodiment of the present invention.

As shown in FIG. 7, the instance segmentation information and the digitized parcel data may be compared with each other to determine, when a region that overlaps by a preset proportion or more exists, the region as parcel object information.

In detail, each of the candidate parcel objects of the instance segmentation information may be compared with a partial region of the digitized parcel data corresponding to each of the candidate parcel objects to determine, when a region that overlaps by a preset proportion or more exists, the region as parcel object information.

Preferably, for each of the candidate parcel objects of the instance segmentation information and the partial region of the digitized parcel data corresponding to each of the candidate parcel objects, an intersection-over-union (IOU) may be used as a measurement index for the overlapping region, and when a value measured through the IOU for each of the candidate parcel objects of the instance segmentation information and the partial region of the digitized parcel data corresponding to each of the candidate parcel objects is greater than or equal to a preset reference value, the region may be determined as the parcel object information.

According to one embodiment of the present invention, for each of the candidate parcel objects of the instance segmentation information and the partial region of the digitized parcel data corresponding to each of the candidate parcel objects, the region may be determined as the parcel object information when the value measured through the IOU is greater than or equal to 0.5, and the region may not be determined as the parcel object information when the value measured through the IOU is less than 0.5.

As described above, instance segmentation information generated by inputting an aerial image to an instance segmentation model and digitized parcel data may be compared with each other to derive parcel object information, so that the need for precise matching may be bypassed, and a plurality of time-series aerial images extracted at different time points may be utilized more effectively.

According to one embodiment of the present invention, the partial region of the digitized parcel data may be an image that displays, for each of the parcels identified in the aerial image, the parcel region at an actual corresponding location corresponding to the candidate parcel object of the parcel in the instance segmentation information.

According to one embodiment of the present invention, the parcel object information may be an image obtained by comparing each of the candidate parcel objects of the instance segmentation information with the partial region of the digitized parcel data corresponding to each of the candidate parcel objects to identify each of the candidate parcel objects that overlap the partial region of the digitized parcel data by a preset proportion or more, and exclude the candidate parcel object that overlaps the partial region of the digitized parcel data in the instance segmentation information by less than the preset proportion.

According to one embodiment of the present invention, for the candidate parcel object of the instance segmentation information and the partial region of the digitized parcel data corresponding to the candidate parcel object, the intersection-over-union (IOU) may be a ratio of a region in which the candidate parcel object of the instance segmentation information and the partial region of the digitized parcel data overlap each other with respect to a region that is a sum of the candidate parcel object of the instance segmentation information and the partial region of the digitized parcel data, according to [Formula 1] below.

$$IOU = \frac{A ⋂ B}{A ⋃ B} \qquad [ Formula 1 ]$$

(A is a candidate parcel object of instance segmentation information, B is a partial region of digitized parcel data, A∩B is a region in which a candidate parcel object of instance segmentation information and a partial region of digitized parcel data overlap each other, and A∪B is a region that is a sum of a candidate parcel object of instance segmentation information and a partial region of digitized parcel data)

According to one embodiment of the present invention, a parcel instance segmentation step may include masking and inputting a remaining region that has not been determined as parcel object information in an aerial image to a classification model, so that information that does not correspond to the parcel object information may be prevented from affecting a process of assigning a class, and thus performance of the classification model may be improved.

In detail, a remaining region that has not been determined as the parcel object information in the aerial image may be processed as a black region.

As described above, a remaining region that has not been determined as parcel object information in an aerial image may be masked and input to a classification model, so that a computational load on a computing resource may be reduced

According to another embodiment of the present invention, the instance segmentation information may be generated from each of a plurality of aerial images, which are obtained by capturing regions including the same target region, and each of a plurality of pieces of instance segmentation information may be compared with the digitized parcel data to determine a plurality of pieces of parcel object information for the aerial images, respectively.

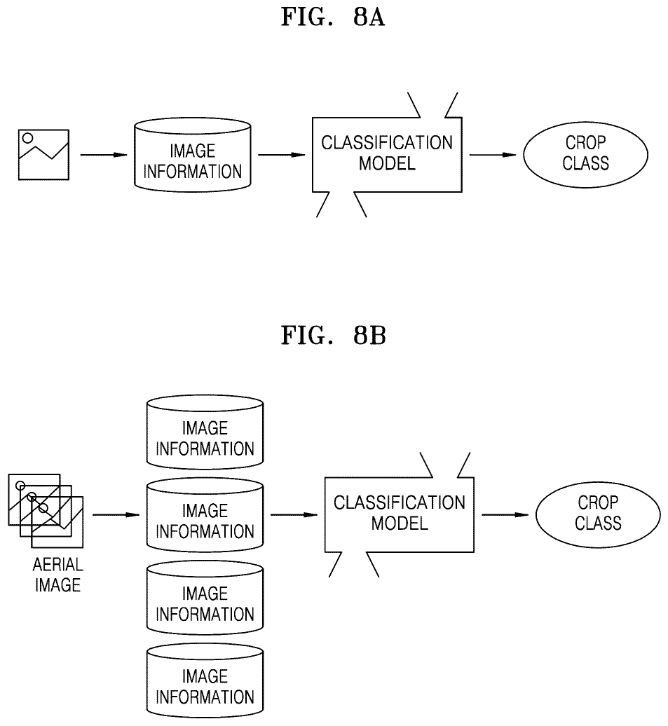

FIGS. 8A and 8B schematically show a classification step according to one embodiment of the present invention.

As shown in FIGS. 8A and 8B, for each of a plurality of parcels extracted from the aerial image by reflecting the parcel object information of the aerial image, image information of the parcel or image characteristic data including data derived from the image information may be input to a classification model trained with deep learning to assign a class to each of the parcels.

As described above, a class may be assigned to each of the plurality of parcels by identifying each of the parcels as an object in an aerial image and inputting information extracted from each of the identified parcels to a classification model, so that the class may be assigned more rapidly to each of the parcels as compared with a process of assigning a class to each of a plurality of parcels by inputting image information on an original aerial image, and accuracy of the classification model may be improved.

According to one embodiment of the present invention, the class may include information on a crop being cultivated on the parcel, the crop including at least one of the following: cabbage, radish, rice, corn, beans, and chili pepper.

According to one embodiment of the present invention, the image information may be an unprocessed original image of the parcel, which is obtained by extracting only an image for the parcel from the parcel object information.

According to one embodiment of the present invention, the image characteristic data may include data related to vitality of vegetation derived from the image information of the parcel.

In detail, the image characteristic data may be derived from the image information of the parcel by using information related to vegetation, including at least one of a normalized difference vegetation index (NDVI), an excess green index (ExG), and a gray level co-occurrence matrix (GLCM).

As described above, a class may be assigned to each of a plurality of parcels by using image characteristic data including data derived from image information for each of a plurality of parcels, so that a computational load on a computing resource may be reduced.

As shown in FIG. 8B, a class may be assigned to each of a plurality of parcels that are commonly identified in a plurality of aerial images based on image information of each of the parcels or image characteristic data including data derived from the image information, which is extracted from each of the aerial images obtained by capturing regions including the same target region.

In detail, for the image information of the parcel extracted from each of the aerial images or the image characteristic data including the data derived from the image information, sequential data in which a plurality of pieces of image information of the parcel or image characteristic data is arranged in a time-series order may be input to the classification model to assign a class in which time-series information is reflected to the parcel.

Preferably, each of the aerial images may include sequential image data corresponding to images extracted from aerial image data, which are obtained by capturing regions including the same target region at different time points, and sequential data in which the image information of the parcel extracted from each of the aerial images or the image characteristic data including the data derived from the image information is arranged in an order of the sequential image data may be input to the classification model to assign a class in which time-series information is reflected to the parcel.

According to one embodiment of the present invention, for each of the aerial images obtained by capturing the regions including the same target region, the image information for each of the parcels extracted from the aerial image or the image characteristic data including the data derived from the image information may be input to the classification model to assign the class to each of the parcels derived from the aerial image, and comparison of the class for each of the parcels derived from each of the aerial images may be performed to finally determine the class for each of the parcels.

In detail, the class that has been assigned the most among the class assigned to the parcel derived from each of the aerial images may be finally determined as the class for the parcel.

According to one embodiment of the present invention, the information or data that is input to the classification model may include at least one of temporal information on a time point including at least one of a date, a time, and a season at which the aerial image has been captured, and spatial information on a space including at least one of a region code, a latitude, and a longitude in which the aerial image has been captured.

In detail, for the image information of each of the parcels or each image characteristic data including data derived from the image information, which is extracted from each of the aerial images obtained by capturing the regions including the same target region, at least one of the temporal information and the spatial information of the aerial image corresponding to the image information or the image characteristic data including the data derived from the image information may be further included and input to the classification model.

According to one embodiment of the present invention, the information or data that is input to the classification model may include: image information on an unprocessed original image of a parcel identified in one of the aerial images; and image characteristic data extracted from an image of a parcel identified in another one of the aerial images.

In detail, the image information may include an original image of the parcel in which a remaining region except for the parcel is masked, and the image characteristic data may include data related to vitality of vegetation derived from the image information of the parcel.

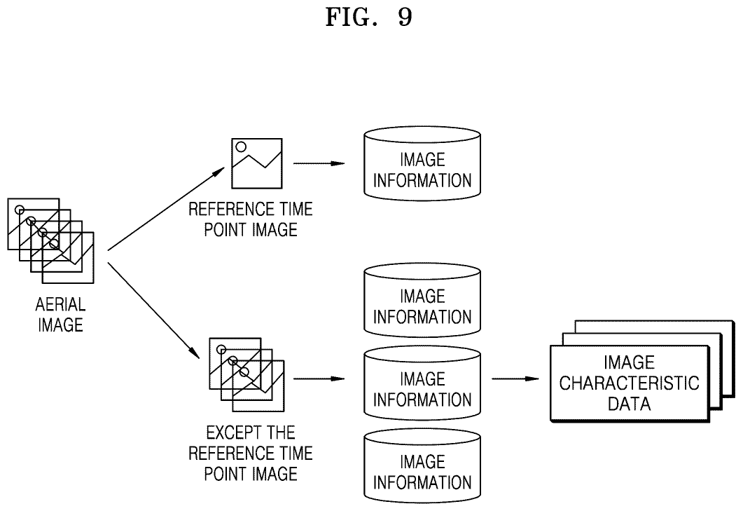

FIG. 9 schematically shows a reference time point image selection step and an image characteristic data extraction step of the classification step according to one embodiment of the present invention.

As shown in FIG. 9, for one reference time point image selected from the aerial images, image information of each of the parcels may be extracted from each of the aerial images, and image characteristic data may be additionally derived from the image information of each of the parcels extracted from each of the aerial images except for the reference time point image.

According to one embodiment of the present invention, an image corresponding to a first time point in the sequential image data corresponding to the images extracted from the aerial image data, which are obtained by capturing the regions including the target region at different time points may be selected as the reference time point image.

According to one embodiment of the present invention, the image characteristic data of each of the parcels extracted from each of the aerial images except for the reference time point image may include time-series information including data related to vitality of vegetation derived from the image information of the parcel.

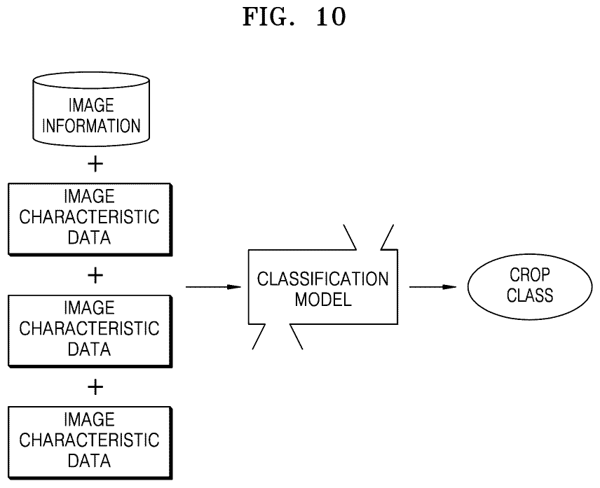

FIG. 10 schematically shows a crop class assignment step of the classification step according to one embodiment of the present invention.

As shown in FIG. 10, for each of the parcels in the aerial image, sequential data in which image information of the reference time point image and image characteristic data of the aerial images except for the reference time point image are arranged in a time-series order may be input to the classification model to assign the class to the parcel.

In detail, the class may be assigned to the parcel by extracting the image information in which the information on the parcel is reflected from the reference time point image, and extracting the image characteristic data in which the time-series information of the parcel is reflected from each of the aerial images except for the reference time point image, so that the class may be assigned in consideration of image information of the parcel at a specific time point as well as information on a time-series change.

As described above, a class may be assigned to a parcel in consideration of image information for the parcel extracted from a reference time point image at a specific time point as well as image characteristic data reflecting data on a time-series change extracted from each of a plurality of aerial images except for the reference time point image, so that performance of a classification model may be improved.

According to one embodiment of the present invention, the class may be assigned to the parcel by using the image information extracted from the reference time point image and the image characteristic data extracted from each of the aerial images except for the reference time point image, so that when compared with a case where the class is assigned to the parcel by using the image information extracted from each of the aerial images, the assignment of the class in which the time-series information is reflected to the parcel may be the same, while the computational load on the computing resource may be further reduced.

According to one embodiment of the present invention, the classification model may derive a result that maximize likelihood of a probability of assigning the class when the image characteristic data is input and a probability of assigning the class when the aerial image is input, according to [Formula 2] below.

$$P ( y \vert ϕ ) P ( y \vert I ) ∝ P ( y \vert I , ϕ ) \qquad [ Formula 2 ]$$

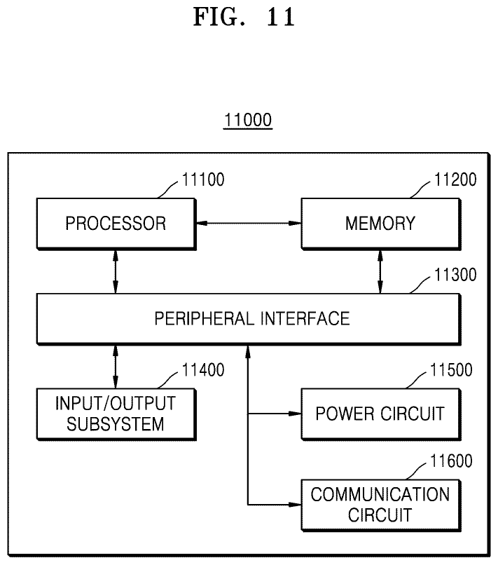

(y is a class, ϕ is image characteristic data, I is an aerial image, P(y|ϕ) is a probability of assigning a class when image characteristic data is input, P(y|I) is a probability of assigning a class when an aerial image is input, and P(y|I,ϕ) is a probability of assigning a class when an aerial image and image characteristic data are input) FIG. 11 schematically shows internal components of the computing device according to one embodiment of the present invention.

A classification model shown in the above-described FIG. 1 may include components of the computing device 11000 shown in FIG. 11.

As shown in FIG. 11, the computing device 11000 may at least include at least one processor 11100, a memory 11200, a peripheral interface 11300, an input/output subsystem (I/O subsystem) 11400, a power circuit 11500, and a communication circuit 11600. The computing device 11000 may correspond to the classification model shown in FIG. 1.

The memory 11200 may include, for example, a high-speed random access memory, a magnetic disk, an SRAM, a DRAM, a ROM, a flash memory, or a non-volatile memory. The memory 11200 may include a software module, an instruction set, or other various data necessary for the operation of the computing device 11000.

The access to the memory 11200 from other components of the processor 11100 or the peripheral interface 11300, may be controlled by the processor 11100.

The peripheral interface 11300 may combine an input and/or output peripheral device of the computing device 11000 to the processor 11100 and the memory 11200. The processor 11100 may execute the software module or the instruction set stored in memory 11200, thereby performing various functions for the computing device 11000 and processing data.

The input/output subsystem may combine various input/output peripheral devices to the peripheral interface 11300. For example, the input/output subsystem may include a controller for combining the peripheral device such as monitor, keyboard, mouse, printer, or a touch screen or sensor, if needed, to the peripheral interface 11300. According to another aspect, the input/output peripheral devices may be combined to the peripheral interface 11300 without passing through the I/O subsystem.

The power circuit 11500 may provide power to all or a portion of the components of the terminal. For example, the power circuit 11500 may include a power failure detection circuit, a power converter or inverter, a power status indicator, a power failure detection circuit, a power converter or inverter, a power status indicator, or any other components for generating, managing, and distributing the power.

The communication circuit 11600 may use at least one external port, thereby enabling communication with other computing devices.

Alternatively, as described above, if necessary, the communication circuit 11600 may transmit and receive an RF signal, also known as an electromagnetic signal, including RF circuitry, thereby enabling communication with other computing devices.

The above embodiment of FIG. 11 is merely an example of the computing device 11000, and the computing device 11000 may have a configuration or arrangement in which some components shown in FIG. 11 are omitted, additional components not shown in FIG. 11 are further provided, or at least two components are combined. For example, a computing device for a communication terminal in a mobile environment may further include a touch screen, a sensor or the like in addition to the components shown in FIG. 11, and the communication circuit 11600 may include a circuit for RF communication of various communication schemes (such as WiFi, 3G, LTE, Bluetooth, NFC, and Zigbee). The components that may be included in the computing device 11000 may be implemented by hardware, software, or a combination of both hardware and software which include at least one integrated circuit specialized in a signal processing or an application.

The methods according to the embodiments of the present invention may be implemented in the form of program instructions to be executed through various computing devices, thereby being recorded in a computer-readable medium. In particular, a program according to an embodiment of the present invention may be configured as a PC-based program or an application dedicated to a mobile terminal. The application to which the present invention is applied may be installed in the computing device 11000 through a file provided by a file distribution system. For example, a file distribution system may include a file transmission unit (not shown) that transmits the file according to the request of the computing device 11000.

The above-mentioned device may be implemented by hardware components, software components, and/or a combination of hardware components and software components. For example, the devices and components described in the embodiments may be implemented by using at least one general purpose computer or special purpose computer, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and at least one software application executed on the operating system. In addition, the processing device may access, store, manipulate, process, and create data in response to the execution of the software. For the further understanding, some cases may have described that one processing device is used, however, it is well known by those skilled in the art that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, a code, and an instruction, or a combination of at least one thereof, and may configure the processing device to operate as desired, or may instruct the processing device independently or collectively. In order to be interpreted by the processor or to provide instructions or data to the processor, the software and/or data may be permanently or temporarily embodied in any type of machine, component, physical device, virtual equipment, computer storage medium or device, or in a signal wave to be transmitted. The software may be distributed over computing devices connected to networks, so as to be stored or executed in a distributed manner. The software and data may be stored in at least one computer-readable recording medium.

The method according to the embodiment may be implemented in the form of program instructions to be executed through various computing mechanisms, thereby being recorded in a computer-readable medium. The computer-readable medium may include program instructions, data files, data structures, and the like, independently or in combination thereof. The program instructions recorded on the medium may be specially designed and configured for the embodiment, or may be known to those skilled in the art of computer software so as to be used. An example of the computer-readable medium includes a magnetic medium such as a hard disk, a floppy disk and a magnetic tape, an optical medium such as a CD-ROM and a DVD, a magneto-optical medium such as a floptical disk, and a hardware device specially configured to store and execute a program instruction such as ROM, RAM, and flash memory. An example of the program instruction includes a high-level language code to be executed by a computer using an interpreter or the like as well as a machine code generated by a compiler. The above hardware device may be configured to operate as at least one software module to perform the operations of the embodiments, and vice versa.

According to one embodiment of the present invention, anyone can safely and conveniently reset an AP setting of a lighting device control apparatus as compared with the related art in which there is a difficulty in resetting a lighting device control apparatus because the lighting device control apparatus is generally installed on a ceiling.

Although the above embodiments have been described with reference to the limited embodiments and drawings, however, it will be understood by those skilled in the art that various changes and modifications may be made from the above-mentioned description. For example, even though the described descriptions may be performed in an order different from the described manner, and/or the described components such as system, structure, device, and circuit may be coupled or combined in a form different from the described manner, or replaced or substituted by other components or equivalents, appropriate results may be achieved.

Therefore, other implementations, other embodiments, and equivalents to the claims are also within the scope of the following claims.

What is claimed is:

1. A method for classifying each parcel in an aerial image, which is performed by a computing device including at least one processor and at least one memory, the method comprising:
a parcel instance segmentation step of inputting the aerial image to an instance segmentation model to generate instance segmentation information for an object identified in the aerial image, and comparing digitized parcel data in a region included in the aerial image with the instance segmentation information to determine parcel object information including information on a boundary of a parcel identified in the aerial image; and
a classification step of inputting, for each of a plurality of parcels extracted from the aerial image by reflecting the parcel object information of the aerial image, image information of the parcel or image characteristic data including data derived from the image information to a classification model trained with deep learning to assign a class to each of the parcels.

2. The method of claim 1, wherein the instance segmentation model includes a segment anything model (SAM) model trained with deep learning and configured to identify the parcel in the aerial image that has been received to generate the instance segmentation information.

3. The method of claim 1, wherein the class includes information on a crop being cultivated on the parcel, the crop including at least one of the following: cabbage, radish, rice, corn, beans, and chili pepper.

4. The method of claim 1, wherein the parcel instance segmentation step includes downsampling the aerial image to increase recognizability of a segmentation target object in the aerial image.

5. The method of claim 1, wherein the parcel instance segmentation step includes generating instance segmentation information from each of a plurality of aerial images, which are obtained by capturing regions including a same target region, and comparing each of a plurality of pieces of instance segmentation information with the digitized parcel data to determine a plurality of pieces of parcel object information for the aerial images, respectively.

6. The method of claim 5, wherein each of the aerial images includes sequential image data corresponding to images extracted from aerial image data, which are obtained by capturing the regions including the target region at different time points.

7. The method of claim 1, wherein the classification step includes assigning a class to each of a plurality of parcels that are commonly identified in a plurality of aerial images based on image information of each of the parcels or image characteristic data including data derived from the image information, which is extracted from each of the aerial images obtained by capturing regions including a same target region.

8. The method of claim 7, wherein the information or data that is input to the classification model includes:
image information on an unprocessed original image of a parcel identified in one of the aerial images; and
image characteristic data extracted from an image of a parcel identified in another one of the aerial images.

9. The method of claim 1, wherein the information or data that is input to the classification model includes at least one of temporal information on a time point including at least one of a date, a time, and a season at which the aerial image has been captured, and spatial information on a space including at least one of a region code, a latitude, and a longitude in which the aerial image has been captured.

10. A system for classifying each parcel in an aerial image, wherein the system is configured to perform:
a parcel instance segmentation step of inputting the aerial image to an instance segmentation model to generate instance segmentation information for an object identified in the aerial image, and comparing digitized parcel data in a region included in the aerial image with the instance segmentation information to determine parcel object information including information on a boundary of a parcel identified in the aerial image; and
a classification step of inputting, based on the parcel object information of the aerial image, image information of each of a plurality of parcels extracted from the aerial image or image characteristic data including data derived from the image information to a classification model trained with deep learning to assign a class to each of the parcels.

11. The system of claim 10, wherein the classification step includes assigning a class to each of a plurality of parcels that are commonly identified in a plurality of aerial images based on the image information of each of the parcels or the image characteristic data including the data derived from the image information, which is extracted from each of the aerial images obtained by capturing regions including a same target region.

12. A computing-readable recording medium for implementing a method for classifying each parcel in an aerial image, which is performed by a computing device including at least one processor and at least one memory, wherein the computing-readable recording medium stores instructions that allow the computing device to perform:
a parcel instance segmentation step of inputting the aerial image to an instance segmentation model to generate instance segmentation information for an object identified in the aerial image, and comparing digitized parcel data in a region included in the aerial image with the instance segmentation information to determine parcel object information including information on a boundary of a parcel identified in the aerial image; and
a classification step of inputting, based on the parcel object information of the aerial image, image information of each of a plurality of parcels extracted from the aerial image or image characteristic data including data derived from the image information to a classification model trained with deep learning to assign a class to each of the parcels.

13. The computing-readable recording medium of claim 12, wherein the classification step includes assigning a class to each of a plurality of parcels that are commonly identified in a plurality of aerial images based on the image information of each of the parcels or the image characteristic data including the data derived from the image information, which is extracted from each of the aerial images obtained by capturing regions including a same target region.
